(19) United States
(12) Patent Application Publication
(10) Pub. No.: US 2014/0025415 A1
(43) Pub. Date: Jan. 23, 2014

(54) DISTRIBUTED CONTINUOUS ANALYTICS

(71) Applicants: Shivaram Venkataraman, Berkeley, CA (US); Indrajit Roy, Mountain View, CA (US); Mehul A. Shah, Saratoga, CA (US); Robert Schreiber, Palo Alto, CA (US); Nathan Lorenzo Binkert, Redwood City, CA (US)

(72) Inventors: Shivaram Venkataraman, Berkeley, CA (US); Indrajit Roy, Mountain View, CA (US); Mehul A. Shah, Saratoga, CA (US); Robert Schreiber, Palo Alto, CA (US); Nathan Lorenzo Binkert, Redwood City, CA (US)

(21) Appl. No.: 13/554,891

(22) Filed: Jul. 20, 2012

(51) Int. Cl. G06Q 10/06

(52) U.S. Cl. 705/7.13

(57) ABSTRACT

A continuing analytics method includes distributing continuous analytics tasks among a number of workers. The workers execute the tasks on data elements stored in a distributed data storage system. Executing a task changes the data elements. In response to the change, a worker that executed a task invokes an update to the data storage system. The worker then increments a version number related to the changed data element, updates the data elements, and notifies other workers of the updated data element.

### BACKGROUND

Businesses and agencies often need or desire to perform complex analysis of large amounts of continuously changing data. The data may be centralized or distributed. Current data analysis systems are inefficient at performing sophisticated data analysis, such as machine learning and graph processing, under these conditions.

### DESCRIPTION OF THE DRAWINGS

The detailed description refers to the following drawings in which like numerals refer to like items, and in which;

FIG. 1 illustrates an embodiment of a continuous analytics system;

FIG. 2 illustrates an example of a continuous analytics program that may be executed by the system of FIG. 1;

FIG. 3 illustrates an example of a partitioned, distributed array; and

FIG. 4 illustrate an example method executed on the system of FIG. 1.

### DETAILED DESCRIPTION

Businesses and agencies may be faced with a need, or may have a desire, to analyze very large quantities of data using complex queries. Some systems are designed to query large databases. Other systems are designed to construct complex queries on databases. However, these systems are not capable of both scaling to query massive amounts of data and performing complex queries such as machine learning, graph processing or dynamic programming. In addition, the data to be queried may be dynamic, meaning the data change frequently.

Disclosed herein are systems and methods that support complex queries of large, dynamic data sets. The systems and methods provide a distributed programming platform for continuously analyzing data. The continuous analytics aspect of the systems and methods, where applications constantly refine their analysis as new data arrives, is useful in many applications, such as user recommendation systems, link analysis, and financial modeling. In addition, unlike batch or single-point processing, the herein disclosed continuous analytics may use partial re-execution, low-latency turnaround, and transitive propagation of changes to dependent tasks. Thus, the herein disclosed systems and methods address at least three specific problems with the current state of data: scale, complexity and dynamics. The systems and methods allow writing complex (statistical, machine learning) queries on large (terabyte+-size), continuously changing data sets that may be re-executed quickly among a set of dependent tasks. The system can support incremental processing of data such that when new data arrives, new results can generally be obtained without restarting the computation from scratch.

More specifically, the systems and methods provide efficient and fast access to large data sets, acquire data from these data sets, divide the data into abstractions referred to herein as distributed arrays, distribute the arrays and the processing tasks among a number of processing platforms, and update the data processing as new data arrives at the large data sets. In an example, the systems and methods extend currently available systems by using language primitives, as add-ons, for scalability, distributed parallelism and continuous analytics. In particular, the systems include the constructs darray and onchange to express those parts of data analysis that may be executed, or re-executed, when data changes. In an aspect, the systems ensure, even though the data is dynamic, that the processes “see” a consistent view of the data. For example, using the methods, if a data analysis process states y=f(x), then y is recomputed automatically whenever x changes. Such continuous analytics methods allow data updates to trigger automatic recalculation of only those parts of the process that transitively depend on the updated data.

As noted above, continuous analytics may be important to businesses and agencies, and many complex analytics are transformations on multi-dimensional arrays. For example, in an Internet product or service delivery system, user recommendations or ratings may play a vital marketing role, and product and service offers may be updated as new customer ratings are added to a ratings dataset. Many examples of such Internet-based systems exist, including Internet-based book stores, online movie delivery systems, hotel reservation services, and similar product and service systems. Other examples include online advertisers, who may sell advertisement opportunities through an auction system, and social network sites. All of these businesses or applications have three characteristics. First, they analyze large amounts of data—from ratings of millions of users to processing links for billions of Web pages. Second, they continuously refine their results by analyzing newly arriving data. Third, they implement complex processes—matrix decomposition, eigenvalue calculation, for example—on data that is incrementally appended or updated. For example, Web page ranging applications and anomaly detection applications calculate eigenvectors of large matrices, recommendation systems implement matrix decomposition, and genome sequencing and financial applications primarily involve array manipulation. Thus, the expression of large sets of data elements in arrays, and the subsequent analysis of the data elements based on these arrays, makes the complex analysis mentioned above not only feasible, but also efficient.

Continuous analytics implies that processing may be “always on”: results are calculated and refined with low latency. Continuous analytics imposes additional challenges compared to simply scaling analytics to a cluster and processing terabytes of data. First, only a few portions of the input data may change; hence only the affected parts of the process should be re-executed.

Current batch processing analytics systems cannot efficiently address such partial computations. Second, since the data is dynamic, it is difficult to express and enforce that distributed processes are run on a consistent view of the data. Finally, programming primitives that support continuous analytics should be able to do so without exposing low-level programming details like message passing.

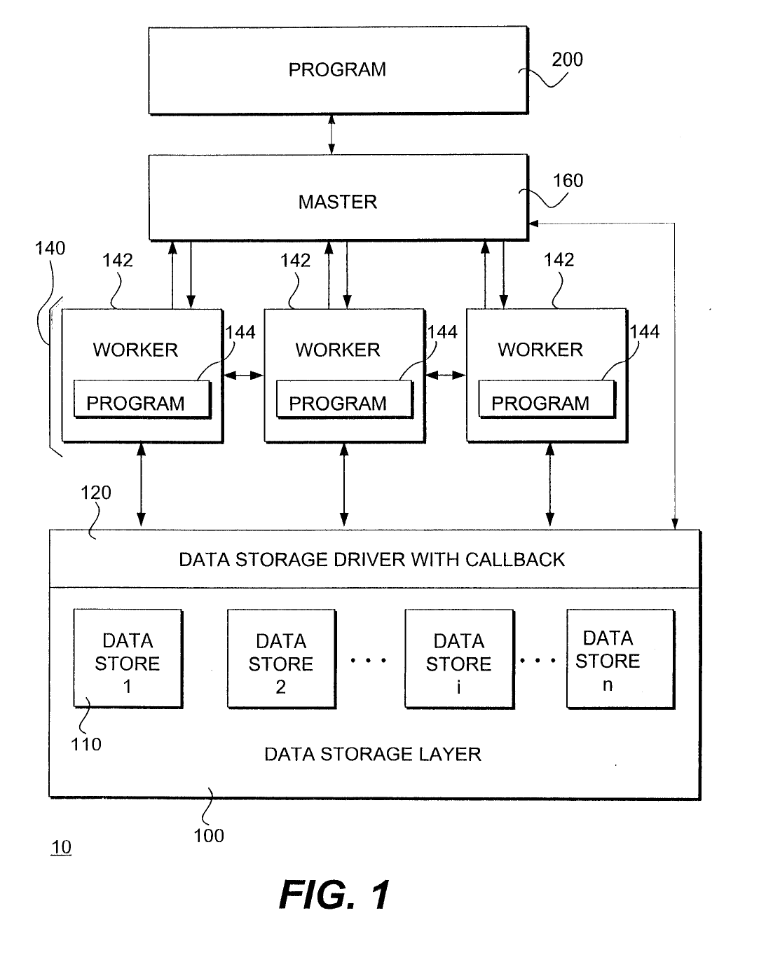

FIG. 1 illustrates an embodiment of a system that supports continuous analytics. Moreover, the system of FIG. 1 scales to address the size of the related dataset. Finally, the system of FIG. 1 applies to centralized or distributed data.

In FIG. 1, system 10 includes storage layer 100, storage driver 120, worker layer 140, master 160, and program layer 200. The storage layer 100 may use a distributed data store architecture. Such an architecture makes it easier to map the complete data, or data subsets, to the distributed arrays. The storage layer 100 allows multiple and different programs to execute on the data. In an example, the storage layer 100 includes distributed data stores 110(i). In this example, a data center may be configured with twenty such data stores 110(1)-110(20); e.g., data servers. Colocating the data stores 110(i) reduces bandwidth problems and provides for fast network connections, for example. However, the data stores 110 may be geographically dispersed. In another alternative, the storage layer 100 includes a single data store (i.e., a centralized data store).

The storage driver 120 communicates between the storage layer 100 and the worker layer 140, which includes workers 142, each of which in turn includes processing devices, communications interfaces, and computer readable mediums, and each of which stores and executes a continuous analytics program 144. The continuous analytics program 144 may include a subset of the programming of a larger continuous analytics program that is maintained in the program layer 200. The workers 142 may be distributed or centralized.

The storage driver 120 reads input data, handles incremental updates, and saves output data. The storage driver 120 may export an interface that allows programs and distributed arrays in the program layer 200, and hence the workers 142 and master 160, to register callbacks on data. Such callbacks notify the different components of the program when new data enters a data store 110 or existing data is modified during incremental processing.

The storage driver 120 also provides for transactional-based changes to data stored in the data stores 110. For example, if a user recommendation file for a hotel chain is to be changed based on a new recommendation from a specific hotel customer, all of the data related to that customer's new recommendation is entered into the appropriate table in the appropriate data store 110. More specifically, if the new recommendation includes three distinct pieces of data, all three pieces of data are entered, or none of the three pieces of data is entered; i.e., the data changes occur atomically. The transactional basis for changing data is required due to the possibility that multiple sources may be writing to and modifying the same data file.

The storage driver 120, as explained below, is notified when data in the storage layer 100 changes, through modification, addition, or subtraction, for example, and in turn notifies the master 160 or workers 142 of the changes.

The master 160 acts as the control thread for execution of program layer 200 programs. The master 160 distributes tasks to workers 142 and receives the results of the task execution from the workers 142. The master 160 and workers 142 form a logical unit. However, in an embodiment, the master 160 and the workers 142 may execute on different physical machines or servers. Thus, the master 160 executes a control and distribution program that distributes tasks associated with a continuous analytics program. The master 160 further receives inputs from the workers 142 when tasks are completed. Finally, the master 160 may re-distribute tasks among the workers 142.

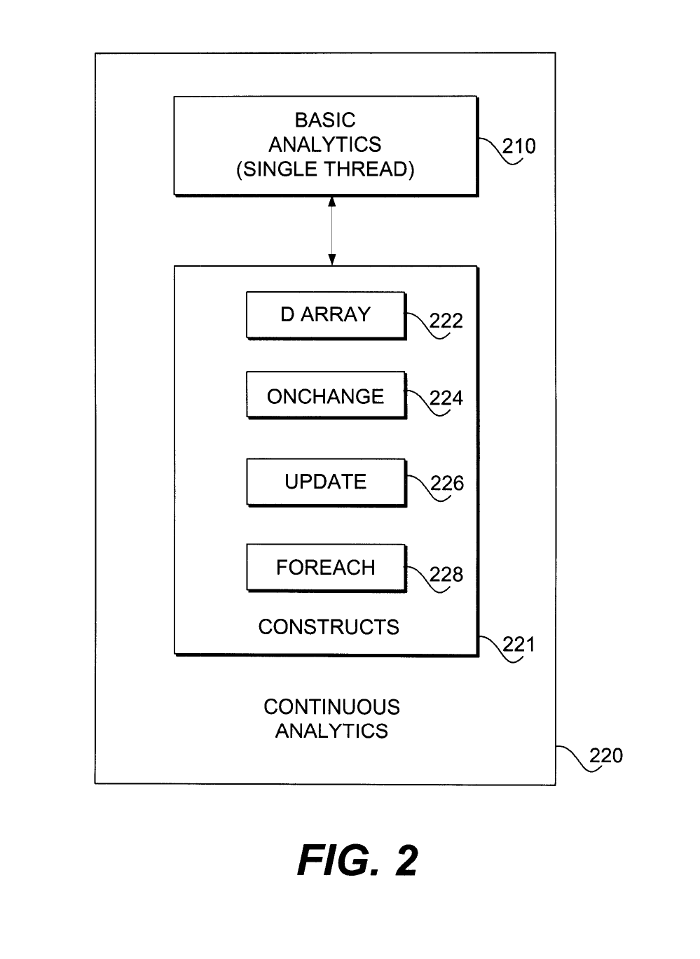

The program layer 200 includes a basic analytics program 210 (see FIG. 2) that is enhanced in certain respects to provide a scalable, continuous analytics program. The program layer 200, in conjunction with the storage driver 120 and storage layer 100, solves the problem of structure and scalability by introducing distributed arrays (through program construct darray 222) to program 210. Distributed arrays provide a shared, in-memory view of multidimensional data stored across multiple data stores 110. That is, the distributed arrays reflect data as stored in the data stores 110. The distributed arrays are data constructs held in the program layer 200. The distributed arrays may include the following characteristics:
Partitioned. Distributed arrays may be partitioned into rows, columns, or blocks. Human users can either specify the size of the partitions or let the continuous analytics runtime environment determine the partitioning.
Shared. Distributed arrays may be read-shared by multiple concurrent tasks, as those tasks are distributed among the workers 142. In an alternative, the human user may specify that the array should be made available to all tasks. Such hints reduce the overhead of remote copying during computation. In an embodiment, concurrent writes to array partitions are not allowed. In another embodiment, concurrent writes are allowed when a human user defines a commutative merge function for the array to correctly merge concurrent modifications. For example, the user may specify the merge function as summation or logical disjunction.
Dynamic. Distributed arrays may be directly constructed from the structure of data in the storage layer 100. The storage driver 120 supports parallel loading of array partitions. If an array registered a callback on the data store, then whenever the data is changed, the array will be notified and updated by the storage driver 120. Thus, distributed arrays are dynamic: both the contents and the size of the distributed arrays may change as data is incrementally updated.
Versioned. In the continuous analytics program, conflicts may arise because of incremental processing—tasks processing old and new data may attempt to update the same data. To avoid conflicts, each partition of a distributed array may be assigned a version. The version of a distributed array may be a concatenation of the versions of its partitions. Writes (using, for example the update construct) to array partitions occur on a new version of the partition. That is, calling update causes the version number of a partition to increment. This version update ensures that concurrent readers of previous versions still have access to data. By versioning arrays, the continuous analytics program can execute multiple concurrent onchange tasks or reuse arrays across different iterations of the program.

FIG. 2 illustrates an embodiment of a continuous analytics program that may be executed on the system 10 of FIG. 1. In FIG. 2, continuous analytics program 220 includes basic analytics program 210 with the following constructs: darray 222, onchange 224, update 226, and foreach 228. In essence, these constructs provide for the execution of continuous processes on a consistent view of data in the storage layer 100. The purpose and operation of these constructs is further explained below. The distributed arrays described above define dependencies by waiting on updates to distributed arrays. For example, onchange(A){. . . } implies that the statements embedded in the brackets { } will be executed whenever array A is updated. Thus, when data referenced by array A is updated, the statement (process or task) embedded in the brackets { } is executed or re-executed on data referenced by array A. Array A also may be a list of distributed arrays or an array partition. The update construct 226 propagates changes to data down to the storage layer 100.

Using update 226 not only triggers the corresponding onchange tasks but also binds the tasks to the data that the tasks should process. That is, the update construct 226 creates a version vector that succinctly describes the state of the array, including the versions of partitions that may be distributed across machines. This version vector is sent to all waiting tasks. Each task fetches the data corresponding to the version vector and, thus, executes on a programmer-defined, consistent view of the data.

The runtime of the continuous analytics program 220 may create tasks on workers 142 for parallel execution. That is, multiple workers execute the same or different tasks on multiple array partitions. The continuous analytics program 220 includes foreach construct 228 to execute such tasks in parallel. The foreach construct 228 may invoke a barrier at the end of each task execution to ensure all other parallel tasks finish before additional or follow-on tasks are started. Thus, foreach construct 228 brings each of the parallel workers 142 to the same ending point with respect to the parallel tasks before any of the parallel workers 142 being another task. Human users can remove the barrier by setting an argument in the foreach construct to false.

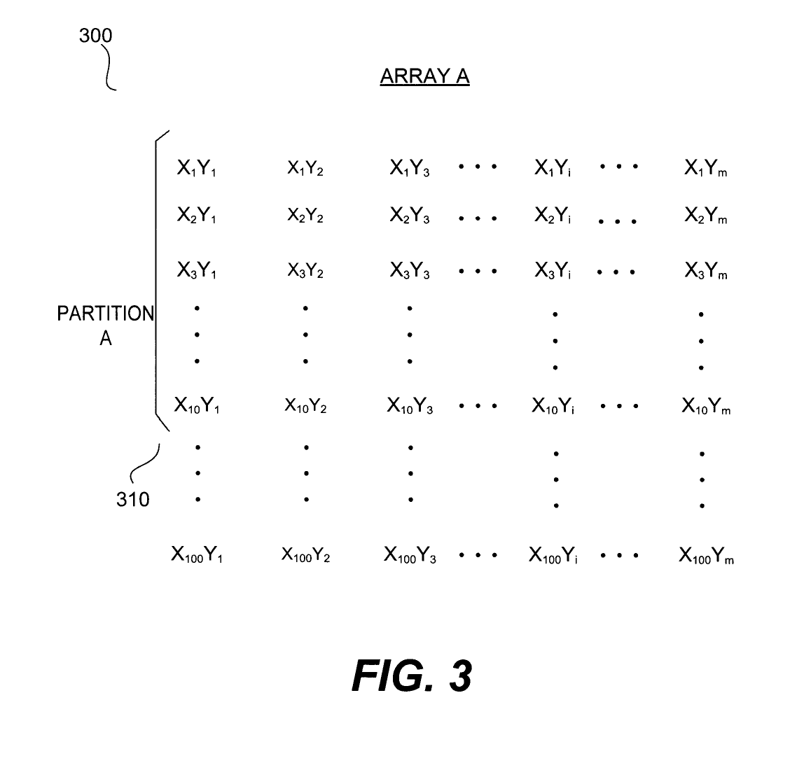

FIG. 3 illustrates an example of a partitioned array. In FIG. 3, array 300 is shown as a 100×100 array. Rows 1-10 of array are partitioned to array 310. Partition 310 may be at version 1. If a worker 142 updates data stored in partition 310, the version increments to version 2, and the worker 142 may write data to the data store location referenced by array partition 310, thereby updating the data in the data store. In an embodiment, the tasks executing on the workers 142 may allow for concurrent reads of the partition 310. In this embodiment, the version number increments only once and applies to the merged data update.

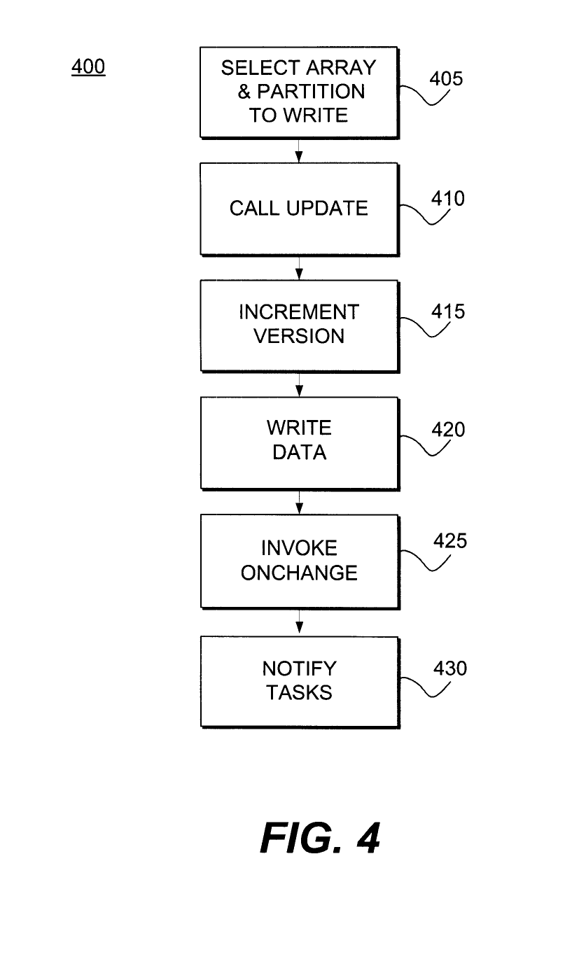

FIG. 4 is a flowchart illustrating methods executed on the system 10.

In FIG. 4, method 400 relates to updating data represented in array A, partition A of FIG. 3. The method 400 begins when worker 142 completes an assigned task and is ready to update data in a data store 110. In block 405, the worker 142 selects an array and a partition to update data in. In block 410, the worker 142 invokes an update. In block 415, the version number of partition A, array A is incremented by one. In block 420, the worker 142 writes data to a location in a data store 110. In block 425, the construct onchange is invoked. In block 430, the storage driver notifies appropriate ones of the workers that the data has been modified. The method 400 then ends.

We claim:

1. A method for executing a continuing analytics process, comprising:
distributing a plurality of continuous analytics tasks among a plurality of workers, wherein the continuing analytics process comprises the plurality of continuous analytics tasks and wherein the tasks perform operations on data elements stored in a distributed data storage system;
executing a task on a worker, wherein executing the task changes the data elements;
invoking an update to the data storage system;
incrementing a version number related to the changed data element;
updating the data elements; and
notifying others of the workers of the updated data element.

2. The method of claim 1, wherein the data elements are referenced in a distributed array.

3. The method of claim 2, wherein the array is partitioned, and wherein the version number applies to a partition containing the data element.

4. The method of claim 3 wherein a second worker calls an update to data elements in the partition, the method further comprising:
saving the incremented version number; and
saving a version number before the incrementing, wherein two versions of the partition are maintained.

5. The method of claim 1, wherein the data updates are merged into a single data update.

6. The method of claim 1, wherein the notification is based on callbacks assigned to the other of the workers.

7. The method of claim 6, wherein the others of the workers automatically execute assigned tasks upon receipt of the notification.

8. The method of claim 1, wherein arrays are distributed across the workers.

9. The method of claim 1, wherein a first worker directly notifies a second worker of a data update or the second worker directly fetches data from the first worker.

10. The method of claim 1, further comprising sharing one or more arrays across all workers.

11. A method for analyzing distributed data using distributed processing, comprising:
storing data in a distributed data storage system;
representing the data in a plurality of distributed arrays;
assigning tasks to distributed processing platforms;
executing the assigned tasks, wherein a task is executed on data in a distributed array;
updating the data in the distributed array after the execution; and
notifying the distributed processing platforms of the updating.

12. The method of claim 11, further comprising:
automatically re-executing the assigned tasks in response to the notification.

13. The method of claim 11 wherein re-executing an assigned task comprises re-executing a subset of the assigned task and re-using results from a previous task execution.

14. A computer readable storage medium that stores a program of instructions for execution by a processor at a distributed processing platform, wherein executing the instructions causes the processor to:
receive a task assignment to execute on distributed data represented by a distributed data array;
execute the assigned task;
update the distributed data after the execution; and
notify other processors at other distributed processing platforms of the data update.

15. The computer readable storage medium of claim 14, wherein the processor is caused to:
increment a version number assigned to the distributed data array before updating the distributed data.
